(19) United States
(12) Patent Application Publication
(10) Pub. No.: US 2012/0224176 A1
(43) Pub. Date: Sep. 6, 2012

(54) Parallel Acquisition Of Spectra For Diffraction Based Overlay

(75) Inventor: Michael J. Hammond, Norton (GB)

(73) Assignee: NANOMETRICS INCORPORATED, Milpitas, CA (US)

(21) Appl. No.: 13/158,988

(22) Filed: Jun. 13, 2011

Related U.S. Application Data
(60) Provisional application No. 61/449,041, filed on Mar. 3, 2011.

(51) Int. Cl. G01B 11/00

(52) U.S. Cl. 356/401

(57) ABSTRACT

Spectra for diffraction based overlay (DBO) in orthogonal directions, i.e., along the X-axis and Y-axis, are acquired in parallel. A broadband light source produces unpolarized broadband light that is simultaneously incident on X-axis and Y-axis DBO targets. A polarization separator, such as a Wollaston prism or planar birefringent element, receives diffracted light from the X-axis and Y-axis DBO targets and separates the TE and TM polarization states of the diffracted light. A detector simultaneously detects the TE and TM polarization states of the diffracted light for both the X-axis DBO target and the Y-axis DBO target as a function of wavelength.

### CROSS-REFERENCE TO PENDING PROVISIONAL APPLICATION

This application claims priority under 35 USC 119 to U.S. Provisional Application No. 61/449,041, filed Mar. 3, 2011, entitled “Diffraction Based Overlay”, which is incorporated herein by reference.

### BACKGROUND

Semiconductor processing for forming integrated circuits requires a series of processing steps. These processing steps include the deposition and patterning of material layers such as insulating layers, polysilicon layers, and metal layers. The material layers are typically patterned using a photoresist layer that is patterned over the material layer using a photomask or reticle. Typically, the photomask has alignment targets or keys that are aligned to fiduciary marks formed in the previous layer on the substrate. However, as the size of integrated circuit features continues to decrease, it becomes increasingly difficult to measure the overlay accuracy of one masking level with respect to the previous level. This overlay metrology problem becomes particularly difficult at submicrometer feature sizes where overlay alignment tolerances are reduced to provide reliable semiconductor devices. One type of overlay measurement is known as diffraction based overlay (DBO) metrology, which may be empirically based or model based.

A fundamental issue with process-control equipment is move-acquire-measure (MAM) time. The empirically based DBO process typically requires the acquisition of spectra from a minimum of six pads on a sample in order to determine the overlay error along the X and Y axes. If each of these spectra were to be acquired sequentially by the metrology tool, a minimum of six stage moves per measurement and a minimum of six integrations for the camera would be required. Given currently available technologies, such a measurement sequence would require a MAM-time of approximately 3 seconds or more.

By acquiring the spectra simultaneously from all of the pads, the MAM-time could be greatly reduced, e.g., approximately 1 second, thereby reducing the cost of ownership of the metrology tool. Thus, parallel acquisition of the spectra from all of the DBO target pads is desired.

### SUMMARY

Spectra for diffraction based overlay (DBO) in orthogonal directions, i.e., along the X-axis and Y-axis, are acquired in parallel. A broadband light source produces unpolarized broadband light that is simultaneously incident on X-axis and Y-axis DBO targets. A polarization separator, such as a Wollaston prism or planar birefringent element, receives diffracted light from the X-axis and Y-axis DBO targets and separates the TE and TM polarization states of the diffracted light. A detector simultaneously detects the TE and TM polarization states of the diffracted light for both the X-axis DBO target and the Y-axis DBO target as a function of wavelength.

### BRIEF DESCRIPTION OF THE DRAWINGS

FIG. 1A illustrates a side view of a DBO target including a number of alignment pads.

FIG. 1B illustrates a top view of two DBO targets for orthogonal directions.

FIG. 2 schematically illustrates analyzing optics for parallel acquisition of spectra for all measurement pads.

FIG. 3 a schematic view of a metrology device that can be used for parallel acquisition of spectra diffraction based overlay.

FIG. 4 is a flow chart illustrating parallel acquisition of DBO data.

FIG. 5 illustrates a row of pixels in the detector that are associated with a particular wavelength and an overlaying image of the four pads from a DBO target.

FIG. 6 illustrates a signal from the row of pixels shown in FIG. 5.

FIG. 7 illustrates an overlay target with a plurality of pads that are contiguous with each other.

FIG. 8 illustrates a signal from a row of pixels that may be produced by an overlay target with pads that are contiguous with each other, as illustrated in FIG. 7.

### DETAILED DESCRIPTION

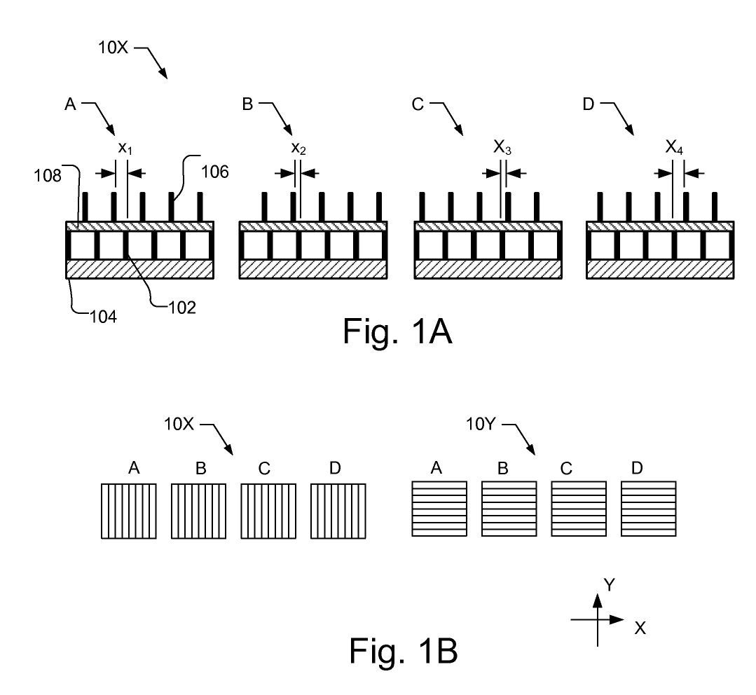

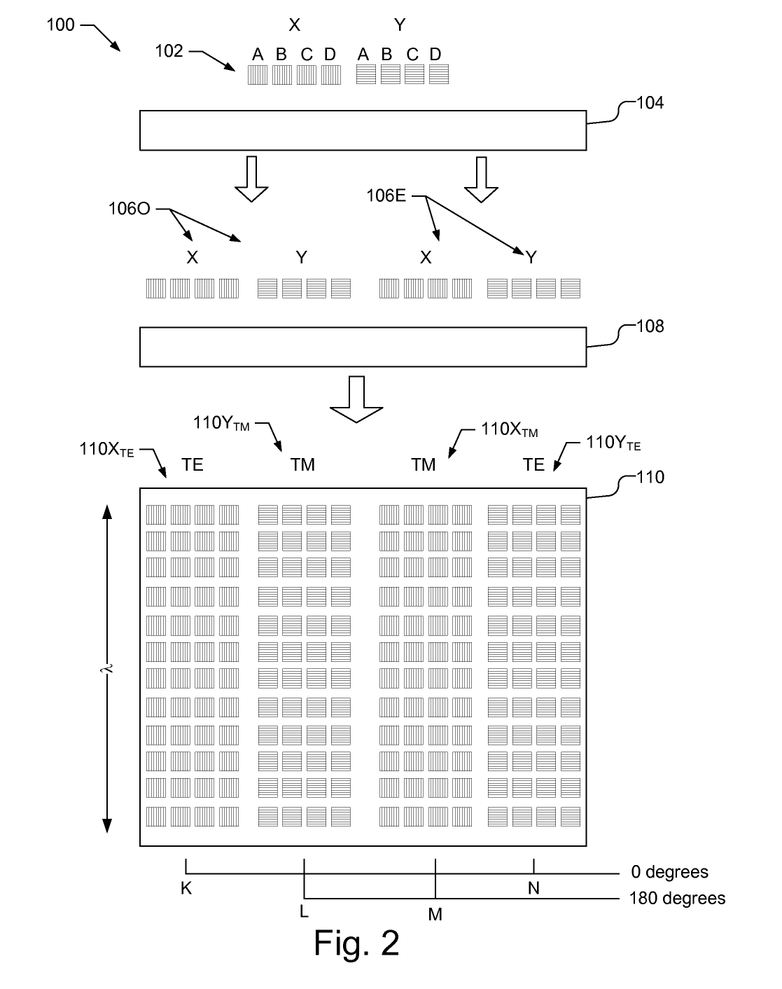

Diffraction based overlay (DBO) metrology is based on the measurement of the diffraction of light from a number of alignment pads. FIG. 1A, by way of example, illustrates a side view of a DBO target 10X including a number of alignment pads A, B, C, and D and FIG. 1B illustrates a top view of DBO target 10X and another DBO target 10Y. Each of the pads A, B, C, and D, as shown in FIG. 1A includes a bottom diffraction grating 12 on a base layer 14 and a top diffraction grating 16 on a top layer 18. In some cases, the top diffraction gratings 16 may be on the same layer as the bottom diffraction gratings 12, or additional layers may be disposed between top diffraction grating 16 and bottom diffraction grating 12. Thus, while each alignment pad includes at least two overlying gratings produced in separate operations, the gratings may be separated from each other by one or more layers or on the same layer. Moreover, DBO targets may have fewer or additional alignment pads than illustrated in FIG. 1A. Further, more than two diffraction gratings may be present in each pad.

An error in the alignment of the top diffraction grating with respect to the bottom diffraction grating of a DBO target 10X produces change in the resulting diffracted light with respect to perfectly aligned top and bottom diffraction gratings. Using a number of alignment pads and comparing the resulting diffraction signal from each alignment pad, the overlay error can be determined, which is sometimes referred to as empirical DBO (eDBO) measurement. In eDBO measurements, the DBO target 10X includes a pre-programmed shift between two or more of the alignment pads, illustrated as x₁, x₂, x₃, and x₄ in pads A, B, C, and D in FIG. 1A. The pre-programmed shift is an intentional shift from perfect alignment of the top and bottom gratings. The use of pre-programmed shifts in DBO targets is well known.

The gratings 12 and 16 used as pads for the DBO process have rulings that are transverse to the direction of the overlay error that they are intended to measure, i.e., target 10X measures overlay error in the X direction and target 10Y measures overlay error in the Y direction, as illustrated in FIG. 1B. The polarization of the light for which there is sensitivity to the overlay error is TE (with respect to the grating rulings). Generally there is also some sensitivity to TM radiation, although the sensitivity may be substantially less than the sensitivity to TE radiation. In the system as described it is possible to make use of sensitivity to TM in addition to sensitivity to the TE radiation. Thus two separate polarizations are required in order to acquire X-overlay and Y-overlay data, unless the sample was rotated by 90° between acquisition of X-overlay data and Y-overlay data.

Parallel X and Y acquisition requires that half of the pads are measured with one linear polarization while the other half is measured with the orthogonal polarization simultaneously for optimal sensitivity. Parallel X and Y acquisition may be achieved by supplying unpolarized light to the sample and separating the two polarizations states of interest between the last beam-splitter surface in the optical system and the detector. For example, a Wollaston prism or a plane piece of birefringent material may be used as a polarization separator.

Parallel acquisition of spectra from all pads greatly reduces the MAM-time, compared to sequential acquisition. Moreover, parallel acquisition of spectra is advantageous as errors caused by light source instabilities are minimized. In comparison, sequential acquisition results in light source instabilities adding noise to the measurement and decreasing precision as a consequence.

FIG. 2 schematically illustrates the analyzing optics 100 used for parallel acquisition of spectra for all measurement pads in DBO targets. As illustrated in FIG. 2, a stigmatic image of an X-axis DBO target and a Y-axis DBO target from a sample is formed by an objective and any other necessary optical components. As illustrated in FIG. 2, the stigmatic image of the targets is represented by four pads labeled A, B, C, and D for each the X-axis and the Y-axis. To produce the stigmatic image, the entire field of pads on the sample is illuminated with unpolarized light. It should be understood that in practice it may be difficult to produce unpolarized light, as after light passes through or is reflected by a beam-splitter, the light is lightly to be at least partially polarized. Accordingly, as used herein, unpolarized light indicates that the light has a substantial component in the two orthogonal directions of the wafer, which is adequate for measurement.

The image of the pads 102 is separated into its two orthogonal polarization components O and E using a polarization separator 104, such as a Wollaston prism or a plane piece of birefringent material. The two differently polarized images 106O and 106E are separated in the direction that the pads are separated, i.e., along the direction of the row pads, to provide a relatively simple optical system. However, if desired, any direction of separation that does not cause the spectra of one polarization to overlap the spectra from the other polarization may be used, e.g., the separation may be at 45 degrees to the direction that the pads are separated provided that the distance of separation was adequate. The composite image of the two differently polarized images 106O and 106E is passed through a spectrometer 108 to an array detector 110.

The array detector 110 is illustrated as illuminated by light that is polarized in the horizontal plane on the left of the array detector 110 and light that is polarized vertically on the right side of the array detector 110. Thus, the TE light is associated with the pads at region 110X_{TE} and at region 110Y_{TE} of the array detector 110, and TM light is associated with pads at region 110Y_{TM} and at region 110X_{TM} of the array detector 110. Thus, the TE and TM polarization states from the X DBO targets and the Y DOB targets is detected simultaneously as a function of wavelength. The measurements from regions 110X_{TE} and at region 110Y_{TE} of the array detector 110, labeled as measurements K and N, are used for the 0° acquisition and measurements from regions 110Y_{TM} and at region 110X_{TM} of the array detector 110, labeled as measurements L and M, are used for the 180° acquisition. Thus, the TE and TM polarization states from the X DBO targets and the Y DOB targets is detected simultaneously as a function of wavelength.

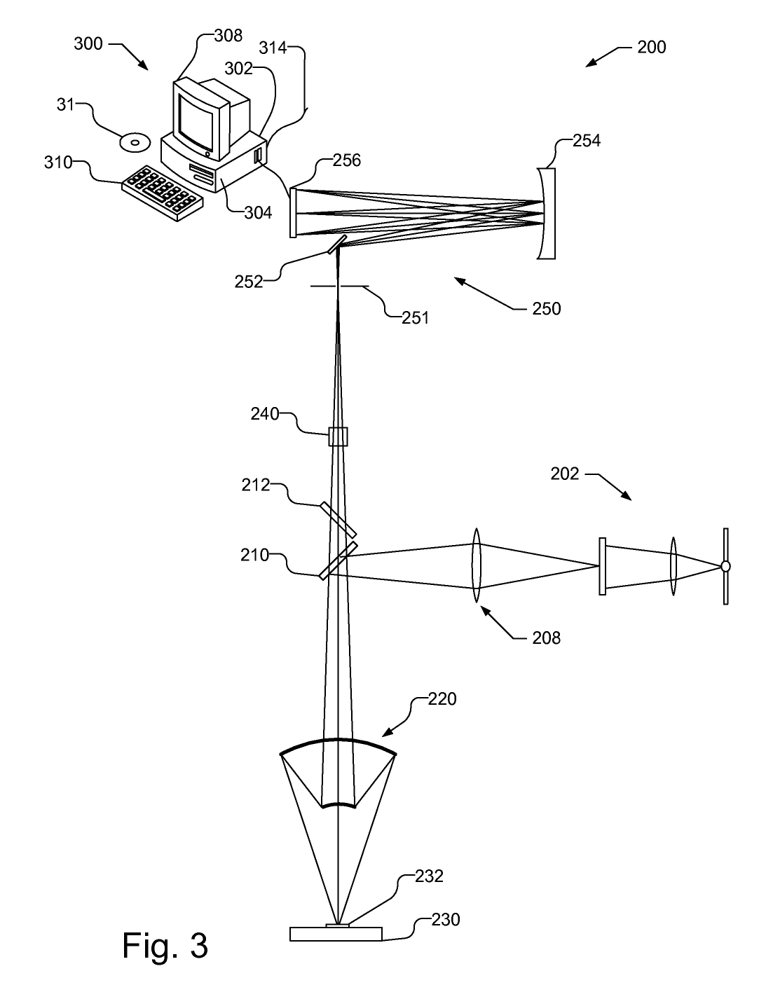

FIG. 3 a schematic view of a metrology device 200 that can be used for parallel acquisition of spectra diffraction based overlay as described above. Metrology device 200 includes a light source 202, such as a Kohler illumination system, that produces a range of wavelengths, e.g., 250 nm to 1000 nm, or any other desired range. In order to achieve the desired separation of light from the two regions of the sample, stigmatic imaging is desirable. Provided that the imaging is stigmatic, then an image of the detector may be projected back through the optical system to the sample. Only light that is reflected from the part of the sample that is coincident with the back projected image of the detector will reach the actual detector.

The above notion suggests that there should be no scattering of light from outside the region where the detector is back-projected into the detector by non-specular processes. In practice, it is expected that there will be some level of contamination of the light reaching the detector by light that had not interacted with the desired part of the wafer. If the non-specular processes are strongly localized, then such a component to the signal could disrupt the measurement. However, if the processes merely add a slowly varying signal to the required signal, then it is not likely that the measurement will be affected. Under these circumstances, a light source 202 such as a Kohler illumination system is desirable. Alternatively, “critical illumination” may be used instead of Kohler illumination. As is well known, with critical illumination an extended source is projected so that an image of the source is conjugate with the sample. A featureless source (or as featureless as possible), e.g., an opal diffuser, is used so as to disrupt the signal as little as possible. Disruption due to variation of intensity of the different parts of the source that are projected onto different pads of the target may be calibrated using a blank wafer or blank target mounted on the stage that holds the wafer. The use of an extended source illuminating a substantial part of the wafer is desirable for pattern-recognition purposes. The selection of the metrology light source for pattern-recognition is important in reducing MAM-time as there is no need to switch sources within the measurement cycle.

The metrology device includes a beam splitter 210 that receives light from the light source 202 after passing through appropriate optical system, illustrated as lens 208. The light is illustrated as reflected by the beam splitter 210 towards an objective 220, such as a Schwarzschild objective with an NA of, e.g., approximately 0.3. The light is focused on the target area 232 of the sample 230, which includes the multiple diffraction pads for both the X and Y axes in a row. The diffracted light is received by the objective 220 and is illustrated as being transmitted through beam splitter 210 and through a second beam splitter 212, which may be used to direct a portion of the light to another optical system, e.g., for pattern recognition and/or focusing. The light is transmitted through a polarization separator 240, such as a Wollaston prism or a planar birefringent element, to produce two differently, e.g., orthogonally, polarized images of the target area 232 of the sample 230. The light is received by a spectrometer 250 by passing through a rectangular aperture 251, after which it is reflected by a mirror 252 to a wavelengths separator, such grating 254 or a prism, and is received by a detector 256, which is coupled to a computer 300. Of course, other geometries of spectrometer 250 are possible, e.g., the mirror 252 is merely illustrative and is not necessary component of a spectrometer, moreover, additional components may be included if desired.

The detector 256 may be, e.g., a back-thinned camera of 256×256 pixels with 24 μm pixels. The appropriate size of the detector 256 is based on the size and number of pads in the overlay target, as well as the characteristics of the optical system, including the object 220 and polarization separator 240. For example, with the use of four pads per target, with pads of 25 μm square, the two targets (X and Y) will have a total length of 2×4×25 μm. Margins the size of approximately one or two pads are used, and thus, the target size is approximately 25 μm×10 would be a good estimate, i.e., 250 μm long×25 μm wide. Using an objective 220 with a magnification of 10×, then the image of the two targets at the input of the spectrometer 250 would be e.g., 2.5 mm×0.25 mm. After splitting by the polarization separator 240, the displacement of the E-ray at the entrance aperture of the spectrometer would be about 3 mm. Thus a feature of 3 mm+2.5 mm would be projected onto the input slit of the spectrometer. A back-thinned camera of 256×256 pixels with 24 μm pixels, has a dimension of approximately 6.14 mm×6.14 mm. In order to collect wavelength information from 250 nm to 1000 nm (750 nm range) at a resolution of 5 nm, a total of 750/5=150 data points are required. Thus, a 256×256 pixel camera is a suitable detector. It may not be necessary to have a back-thinned camera, as any camera with appropriate spectral sensitivity may be used.

[The computer 300 may include a processor 302 with memory 304, as well as a user interface including e.g., a display 308 and input devices 310. A computer-usable medium 312 having computer-readable program code embodied may be used by the computer 300 for causing the processor to control the metrology device 200 and to perform the functions including the analysis described herein. The data structures and software code for automatically implementing one or more acts described in this detailed description can be implemented by one of ordinary skill in the art in light of the present disclosure and stored, e.g., on a computer usable medium 312, which may be any device or medium that can store code and/or data for use by a computer system such as processor 302. The computer-usable medium 312 may be, but is not limited to, magnetic and optical storage devices such as disk drives, magnetic tape, compact discs, and DVDs (digital versatile discs or digital video discs). A communication port 314 may also be used to receive instructions that are used to program the computer 300 to perform any one or more of the functions described herein and may represent any type of communication connection, such as to the internet or any other computer network. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described.

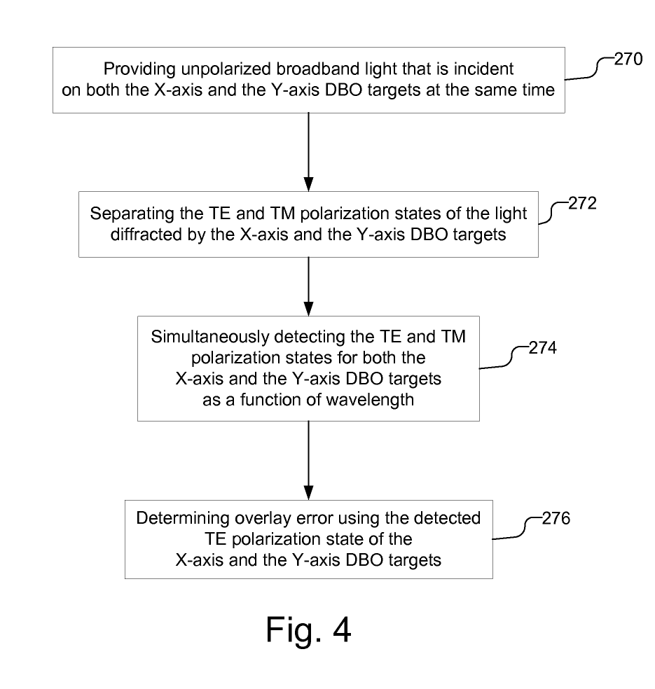

FIG. 4 is a flow chart illustrating parallel acquisition of X-axis and Y-axis DBO data. As illustrated, unpolarized broadband light is provided, which is simultaneously incident the X-axis DBO target and the Y-axis DBO target (270). The X-axis and Y-axis DBO targets include a plurality of pads that are aligned in a row. The TE and TM polarization states of the light diffracted from the X-axis DBO target and the Y-axis DBO target is separated (272) after the last beam-splitter surface, e.g., beam splitter 212 in FIG. 3, in the optical system and the detector, e.g., detector 256. The polarization states are separated along a direction that is parallel to the row of pads in the image of the X-axis and the Y-axis DBO targets. The TE and TM polarization states are simultaneously detected for both the X-axis and the Y-axis DBO targets as a function of wavelength (274). The overlay error for the X-axis and Y-axis may then be determined in a computer implemented process using at least the detected TE polarization state for the X-axis and the Y-axis DBO targets (276). The resulting measurements of overlay error along the X-axis and Y-axis are then stored in memory or storage, e.g., memory 304, and may be displayed, or otherwise reported.

The sensitivity to overlay at any given wavelength for either polarization is expected to be a strong function of wavelength. The sensitivity is part of the measurement and is provided by the third (and fourth if there is one) pad with the programmed offset. The reported measurement may include an average of the measurements at all wavelengths and polarizations weighted by the sensitivities at those wavelengths and polarizations.

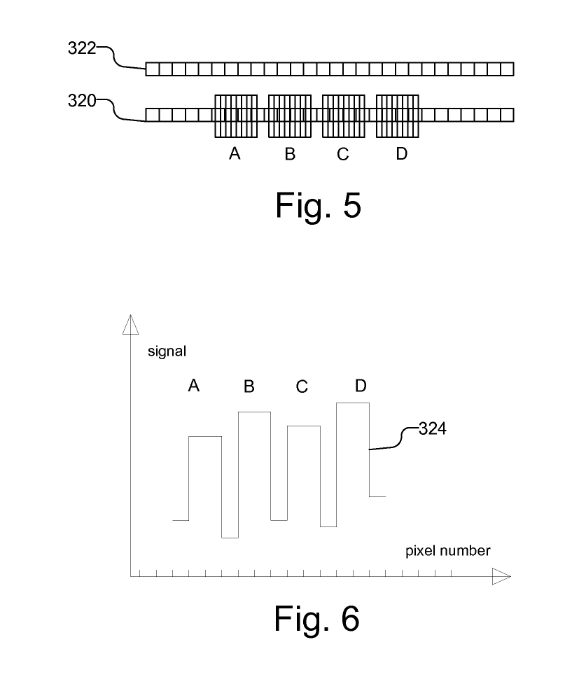

FIG. 5 illustrates a row of pixels 320 in the detector 256 that are associated with a particular wavelength, e.g., 550 nm, with another row of pixels 262 associated with a different wavelength, e.g., 540 nm, illustrated as above row 320. The row of pixels 320 and 322, for example, may be rows of pixels in region 110X_{TE} in FIG. 2. Images of the four different pads, labeled A, B, C, and D, produced by TE polarized light having wavelength, e.g., 550 nm, are illustrated over row of pixels 320. The four different pads A, B, C, and D in the overlay mark each have different overlay offsets, and thus, the signal resulting from row 320 will be different for each of the pads. FIG. 6 illustrates an example of a signal 324 from row 320 produced by the images of the four different pads A, B, C, and D.

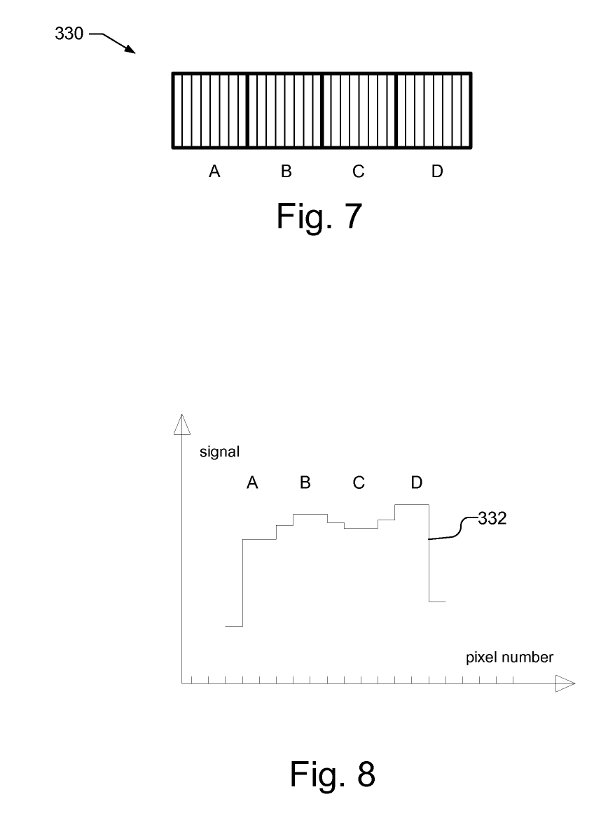

The measured signal from the detector may be in the form of a wave. The signal 324 must be sensitive to the overlay error in the pads A, B, C, and D, however, the difference in signal from one pad to another is not expected to be great. For example, the difference in the signal between a pad and the surrounding material is likely to exceed the difference in the signals between different pads. Accordingly, the gap between the pads may be reduced to zero. FIG. 7, by way of example, illustrates an overlay target 330 that includes four pads A, B, C, and D, in which there is no gap between the pads, i.e., each pad is contiguous with another pad to produce a continuous overlay target 330.

FIG. 8 illustrates an example of a signal 332 that may be produced by an overlay target 330 with no gaps between the pads, as illustrated in FIG. 7. The signal 332 over the four pads A, B, C, and D, now may be represented by a wave and the pixels near the edges of the images of the pads can carry some useable information. With the use of a non-continuous target, the signal 324 produced by the pixels between the pads, e.g., in FIG. 5, were unusable for measurement. Moreover, the signal 324 produced by the pixels at the edges of the pads were also rendered unusable for measurement.

The measurement of the overlay error is a comparison of the relative signal levels produced by pads A, B, C and D, for each wavelength. The absolute signal level is not the metric of interest. Thus, a small DC component added to the signal will have little or no effect on the measurement. It is noted, however, that a large DC component will add to the Poisson noise and will also reduce the total number of “signal” photons that can be collected, and is therefore discouraged.

In many applications, such as scatterometry and metrology of materials, thin films, etc., it is important to know the polarization state of the incident beam. In the present embodiment, sensitivity is expected to be predominantly with radiation with a TE polarization state. Sensitivity in the TM radiation is not expected to correlate to the sensitivity in the TE radiation, i.e., the signal from TM radiation could have a positive or negative coefficient when the TE radiation has a positive coefficient. Thus, it is desirable to ensure that there is good polarization separation. Nevertheless, good results may be achieved even with the TE radiation slightly polluted with TM radiation, provided that the TM signal was less than, e.g., 10% of the TE signal.

Any optic with a finite NA will modify the polarization state of skew rays, which is a fundamental geometrical effect, not just a matter of optical design issues. Skew rays are produced by any optical component with a finite numerical aperture. Thus, it is not possible with ordinary polarizing components to project an incoming beam of light having a polarization state parallel to gratings on a pad if the optical component has a finite numerical aperture. Accordingly, in any practical system, it is expected that a few percent of the signal at the detector will not be pure TE or TM polarization states. However, as noted above, the addition of a small amount of signal that displays no sensitivity to overlay is not likely to be detrimental provided that the magnitude of the minority signal remains small.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. An apparatus for parallel acquisition of spectra for diffraction based overlay (DBO), the apparatus comprising:
a broadband light source that produces unpolarized broadband light, the unpolarized broadband light is simultaneously incident on an X-axis DBO target and a Y-axis DBO target;
a polarization separator that receives diffracted light from the X-axis DBO target and the Y-axis DBO target, the polarization separator separates TE and TM polarization states of the diffracted light for both the X-axis DBO target and the Y-axis DBO target; and
a detector for simultaneously detecting the TE and TM polarization states of the diffracted light for both the X-axis DBO target and the Y-axis DBO target as a function of wavelength.

2. The apparatus of claim 1, further comprising a wavelength separator that separates wavelengths of the diffracted light for both the X-axis DBO target and the Y-axis DBO target before the diffracted light is detected by the detector.

3. The apparatus of claim 1, wherein the X-axis DBO target and the Y-axis DBO target each comprise a plurality of pads, wherein the plurality of pads for both the X-axis DBO target and the Y-axis DBO target are aligned in a row.

4. The apparatus of claim 3, wherein the polarization separator separates the TE and TM polarization states of the diffracted light for both the X-axis DBO target and the Y-axis DBO target along a direction in which spectra from the TE and TM polarization states does not overlap.

5. The apparatus of claim 3, wherein the plurality of pads in the X-axis DBO target are contiguous with each other and the plurality of pads in the Y-axis DBO target are contiguous with each other.

6. The apparatus of claim 1, wherein there are no beam splitters between the polarization separator and the detector.

7. The apparatus of claim 1, wherein the polarization separator is a Wollaston prism.

8. The apparatus of claim 1, wherein the polarization separator is a planar birefringent element.

9. The apparatus of claim 1, wherein the broadband light source that produces the unpolarized broadband light is one of a Kohler illumination system and a critical illumination system.

10. The apparatus of claim 1, further comprising a computer configured to determine overlay error along an X-axis and a Y-axis using the TE polarization state of the diffracted light for the X-axis DBO target and the Y-axis DBO target that is detected as a function of wavelength.

11. A method of parallel acquisition of spectra for diffraction based overlay (DBO), the method comprising:
providing unpolarized broadband light that is simultaneously incident on an X-axis DBO target and a Y-axis DBO target;
separating TE and TM polarization states of diffracted light from the X-axis DBO target and the Y-axis DBO target; and
simultaneously detecting the TE and TM polarization states of the diffracted light for both the X-axis DBO target and the Y-axis DBO target as a function of wavelength.

12. The method of claim 11, further comprising determining overlay error along an X-axis and a Y-axis using the TE polarization state of the diffracted light for the X-axis DBO target and the Y-axis DBO target that is detected as a function of wavelength.

13. The method of claim 11, further comprising separating wavelengths of the diffracted light for both the X-axis DBO target and the Y-axis DBO target before simultaneously detecting the TE and TM polarization states of the diffracted light.

14. The method of claim 11, wherein the X-axis DBO target and the Y-axis DBO target each comprise a plurality of pads, wherein the plurality of pads for both the X-axis DBO target and the Y-axis DBO target are aligned in a row.

15. The method of claim 14, wherein separating the TE and TM polarization states of the of diffracted light separates the TE and TM polarization states of the diffracted light for both the X-axis DBO target and the Y-axis DBO target along a direction in which spectra from the TE and TM polarization states does not overlap

16. The method of claim 14, wherein the plurality of pads in the X-axis DBO target are contiguous with each other and the plurality of pads in the Y-axis DBO target are contiguous with each other.

17. The method of claim 11, wherein the light passes through no beam splitters after the TE and TM polarization states are separated.

18. The method of claim 11, wherein separating the TE and TM polarization states of the diffracted light is performed by a Wollaston prism.

19. The method of claim 11, wherein separating the TE and TM polarization states of the diffracted light is performed by a planar birefringent element.

20. The method of claim 11, wherein providing the unpolarized broadband light is performed using one of a Kohler illumination system and a critical illumination system.
